(19) United States
(12) Patent Application Publication
(10) Pub. No.: US 2019/0306320 A1
(43) Pub. Date: Oct. 3, 2019

(54) TRANSMISSION APPARATUS, TELECONFERENCE SYSTEM, INFORMATION PROCESSING METHOD, AND RECORDING MEDIUM

(71) Applicant: Tatsuroh SUGIOKA, Kanagawa (JP)

(72) Inventor: Tatsuroh SUGIOKA, Kanagawa (JP)

(73) Assignee: Ricoh Company, Ltd., Tokyo (JP)

(21) Appl. No.: 16/352,007

(22) Filed: Mar. 13, 2019

(30) Foreign Application Priority Data
Mar. 29, 2018 (JP) 2018-064950

(51) Int. Cl. H04M 3/56; H04L 29/06

(52) U.S. Cl. CPC H04M 3/56; H04L 65/1069; H04L 65/403

(57) ABSTRACT

A transmission apparatus includes: a first connector configured to allow an external terminal to connect to the transmission apparatus; a second connector configured to allow an external microphone to connect to the transmission apparatus; a detector configured to detect the external terminal connected to the first connector and detect the external microphone connected to the second connector; a mixer configured to mix a sound signal output from the external terminal and a sound signal output from the external microphone or and a sound signal output from an internal microphone provided in the transmission apparatus; a selector configured to select a sound signal, which is targeted for mixing, based on a detection result of the detector; and a transfer controller configured to transfer, to one or more second transmission apparatuses, a sound signal resulting from the mixing by the mixer.

### CROSS-REFERENCE TO RELATED APPLICATIONS

The present application claims priority under 35 U.S.C. § 119 to Japanese Patent Application No. 2018-064950, filed on Mar. 29, 2018. The contents of which are incorporated herein by reference in their entirety.

### BACKGROUND OF THE INVENTION

### 1. Field of the Invention

The present invention relates to a transmission apparatus, a teleconference system, an information processing method, and a recording medium.

### 2. Description of the Related Art

In recent years, there are teleconference systems capable of holding conferences in remote locations by using a communication network such as the Internet. In such the teleconference systems, a transmission apparatus installed in a conference room transmits videos and sounds inside the conference room to other transmission apparatuses installed at remote locations to share the videos and sounds among the transmission apparatuses. When there are multiple sound generation sources, sound mixing is sometimes conducted.

A teleconference system for sharing sounds among multiple transmission apparatuses has been disclosed such that the system includes: a mixer that includes a plurality of input terminals and mixes sound signals input from the input terminals; and a unit that selects sound signals targeted for mixing in accordance with the order of priority previously assigned to each transmission apparatus when the number of transmission apparatuses from which sound signals are input is more than the number of input terminals (for example, Japanese Unexamined Patent Application Publication No. 2008-301124). It is possible to automatically select sound signals targeted for mixing in a transmission apparatus on the receiving side.

In the above-described teleconference system, it is sometimes needed to select mixing targets also in a transmission apparatus on the transmitting side. For example, when sharing, with other transmission apparatuses, sounds inside a conference room collected by an internal microphone of a transmission apparatus or an external microphone connected to the transmission apparatus and sounds output from an external terminal connected to the transmission apparatus (for example, sounds included in moving image content reproduced by a PC (personal computer) connected to the transmission apparatus), there is a need to properly select and switch a sound signal targeted for mixing depending on the connection state of a peripheral device, such as the external microphone or the external terminal. However, in the conventional technologies, it is needed to manually perform the switching of a mixing target in the transmission apparatus on the transmitting side.

### SUMMARY OF THE INVENTION

According to one aspect of the present invention, a transmission apparatus includes: a first connector configured to allow an external terminal to connect to the transmission apparatus; a second connector configured to allow an external microphone to connect to the transmission apparatus; a detector configured to detect the external terminal connected to the first connector and detect the external microphone connected to the second connector; a mixer configured to mix a sound signal output from the external terminal and a sound signal output from the external microphone or and a sound signal output from an internal microphone provided in the transmission apparatus; a selector configured to select a sound signal, which is targeted for mixing, based on a detection result of the detector; and a transfer controller configured to transfer, to one or more second transmission apparatuses, a sound signal resulting from the mixing by the mixer.

### BRIEF DESCRIPTION OF THE DRAWINGS

FIG. 1 is a diagram illustrating an example of the configuration of a teleconference system according to an embodiment;

FIG. 2 is a diagram illustrating an example of the hardware configuration of a transmission apparatus according to the embodiment;

FIG. 3 is a diagram illustrating an example of the hardware configuration of an external terminal according to the embodiment;

FIG. 4 is a diagram illustrating an example of the functional configuration of the transmission apparatus according to the embodiment;

FIG. 5 is a diagram illustrating an example of the data structure of a mixing-target selection table according to the embodiment;

FIG. 6 is a diagram conceptually illustrating transfer targets in mixing patterns according to the embodiment;

FIG. 7 is a flowchart illustrating an example of the process when the transmission apparatus conducts mixing according to the embodiment; and

FIG. 8 is a flowchart illustrating an example of the process when mixing is not conducted in the transmission apparatus according to the embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object an embodiment is to make it possible to properly and automatically switch a mixing target in a transmission apparatus on the transmitting side depending on the connection state of a peripheral device.

With reference to the attached drawings, a detailed explanation is given below for an embodiment of a transmission apparatus, a teleconference system, an information processing method, and a recording medium. The present invention is not limited to the following embodiment, and components in the following embodiment include the ones that may be easily developed by a person skilled in the art, substantially the same ones, and the ones within what is called the range of equivalents. Various types of omission, replacement, modification, and combination may be made to components without departing from the scope of the following embodiment.

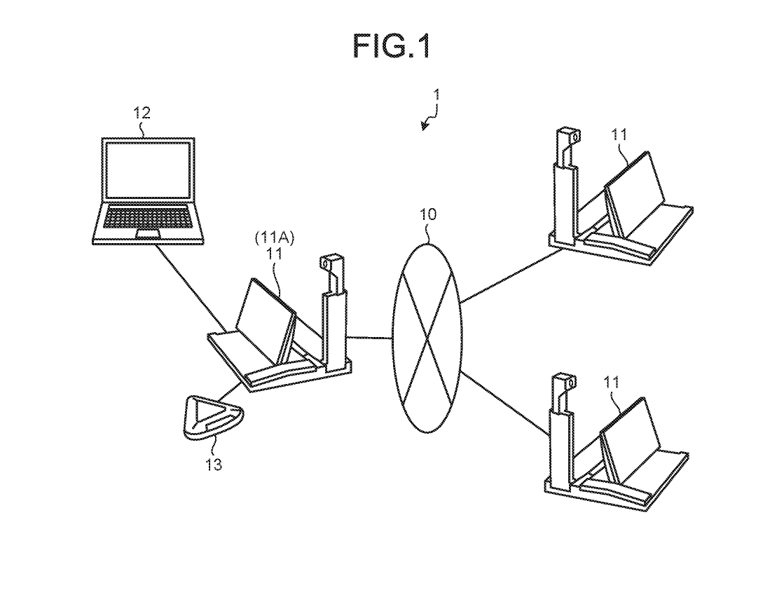

FIG. 1 is a diagram that illustrates an example of the configuration of a teleconference system 1 according to the embodiment. The teleconference system 1 is a system that enables sharing of videos and sounds among a plurality of transmission apparatuses 11 connected to a network 10. Teleconference is executable by installing the transmission apparatuses 11 at hubs (for example, conference rooms) that are apart from each other. In the example illustrated in FIG. 1, an external terminal 12 and an external microphone 13 are connected to the single transmission apparatus 11 (11A).

The network 10 includes the Internet configured by using for example TCP/IP (Transmission Control Protocol/Internet Protocol), a LAN (Local Area Network) configured by using for example IEEE 1394 (Institute of Electrical and Electronics Engineers 1394), Ethernet, or Wi-Fi, or the like.

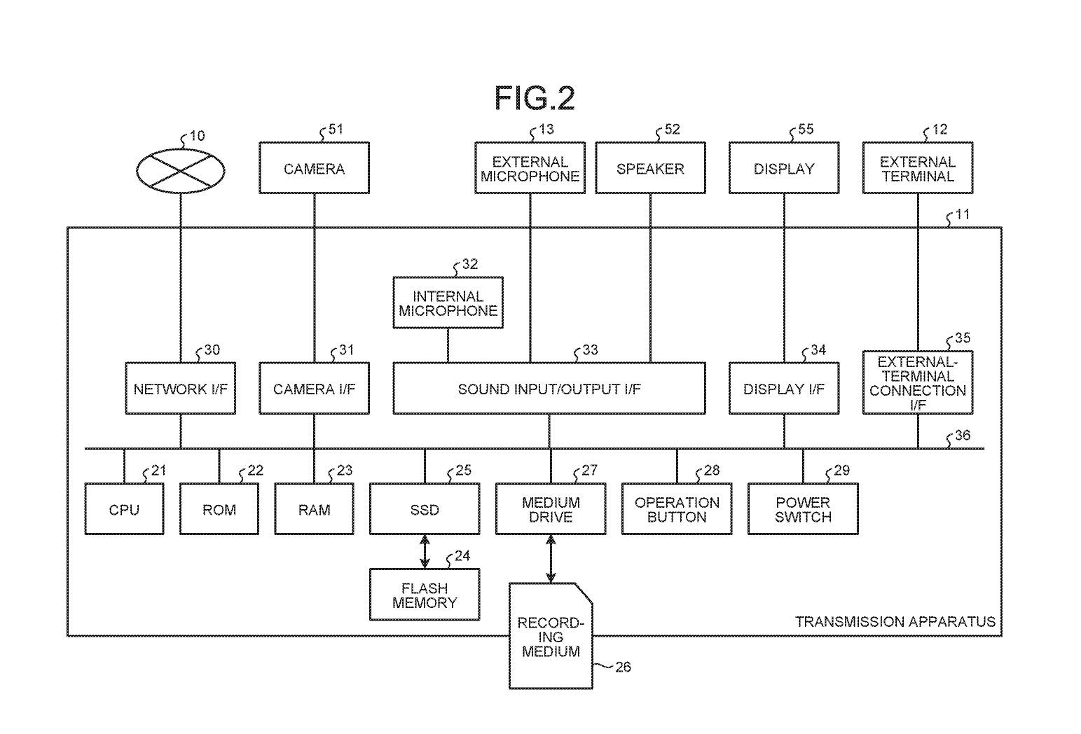

FIG. 2 is a diagram that illustrates an example of the hardware configuration of the transmission apparatus 11 according to the embodiment. The transmission apparatus 11 includes: a CPU (central processing unit) 21 that controls the overall operation of the transmission apparatus 11; a ROM (read only memory) 22 that stores various programs; a RAM (random access memory) 23 used as a work area for the CPU 21; an SSD (solid state drive) 25 that controls reading or writing various types of data from or in a flash memory 24 under the control of the CPU 21; a medium drive 27 that controls reading or writing various types of data from or in a recording medium 26 such as a memory card; an operation button 28, such as a cursor, operated to for example select the destination for the transmission apparatus 11; a power switch 29 for switching on/off the power of the transmission apparatus 11; and a network I/F 30 for data transmission by using the network 10.

The transmission apparatus 11 further includes a camera I/F 31 that controls driving of a camera 51, which takes videos of a user (for example, a participant in a conference) and outputs video data, and transmits and receives data to and from the camera 51. The camera 51 is, for example, a device having an imaging device built-in, such as, CMOS (complementary metal oxide semiconductor) or CCD (charge coupled device image sensor), which conducts photoelectric conversion on a light reflected from an object and acquires image data. The camera 51 is connected to the camera I/F 31 via a USB (universal serial bus) cable, or the like.

Furthermore, the transmission apparatus 11 includes an internal microphone 32 and a sound input/output I/F 33. The internal microphone 32 is a sound collecting device that is built in the transmission apparatus 11 to output sound signals resulting from converting sounds around the transmission apparatus 11 (inside a conference room, or the like) into electric signals. The sound input/output I/F 33 is connected to the internal microphone 32, the external microphone 13, and a speaker 52. The external microphone 13 is an externally connected sound collecting device that outputs sound signals resulting from converting sounds around the transmission apparatus 11 into electric signals. The speaker 52 is an externally connected device that outputs electric signals generated by the transmission apparatus 11 as sounds. The external microphone 13 and the speaker 52 are connected in a removable manner to the sound input/output I/F 33 via a USB cable, or the like. The sound input/output I/F 33 conducts processing on input/output of sound signals among the internal microphone 32, the external microphone 13, and the speaker 52 under the control of the CPU 21.

The transmission apparatus 11 further includes a display I/F 34 that transmits image data to a display 55 under the control of the CPU 21. The display 55 is connected to the display I/F 34 via a cable 56. The cable 56 may be an analog RGB (VGA) signal cable, a component video cable, an HDMI (High-Definition Multimedia Interface) (registered trademark) cable, DVI (Digital Video Interactive) cable, or the like. Furthermore, the device connected to the display I/F 34 may be not only the display 55 but also a projection device, such as a projector.

Furthermore, the transmission apparatus 11 includes an external-terminal connection I/F 35 connected to the external terminal 12. The external terminal 12 is a device that outputs sound signals, and the like, and it may be, for example, a PC. The external terminal 12 is connected in a removable manner to the external-terminal connection I/F 35 via a USB cable, HDMI cable, or the like. The external-terminal connection I/F 35 conducts recognition processing of the external terminal 12, transmitting/receiving processing of data, and the like, under the control of the CPU 21.

The transmission apparatus 11 further includes a bus line 36, such as an address bus or a data bus, for electrically connecting each of the above-described components.

The recording medium 26 is configured to be attached to or detached from the transmission apparatus 11. Although the flash memory 24 is used in the configuration described in the embodiment, this is not a limitation and, for example, an EEPROM (Electrically Erasable and Programmable ROM) may be used as long as it is a nonvolatile memory that reads or writes data under the control of the CPU 21.

A program executed by the transmission apparatus 11 may be distributed by being recorded in a recording medium readable by a computer, such as the recording medium 26, in a form of file installable and executable. Furthermore, the program may be stored in not the flash memory 24 but the ROM 22. Moreover, the program may be downloaded from the server via the network I/F 30 and recorded in the flash memory 24, the recording medium 26, or the like.

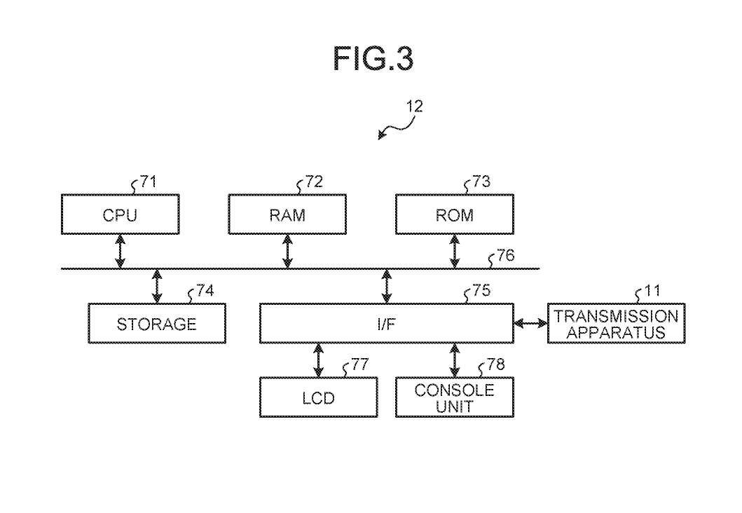

FIG. 3 is a diagram that illustrates an example of the hardware configuration of the external terminal 12 according to the embodiment. The external terminal 12 according to the present embodiment has the same configuration as that of a typical computer. The external terminal 12 is configured by connecting a CPU 71, a RAM 72, a ROM 73, a storage 74, and an I/F 75 via a bus 76. The I/F 75 is connected to an LCD (liquid crystal display) 77, a console unit 78, and the transmission apparatus 11.

The CPU 71 is an electronic circuit that performs calculation processing, and it performs a process to control the overall operation of the external terminal 12. The RAM 72 is a volatile storage device that is capable of reading and writing information at high speed, and it functions as a work area when the CPU 71 processes information. The ROM 73 is a read-only non-volatile storage device, and it stores programs such as firmware. The storage 74 is a non-volatile storage device capable of reading and writing information, and it stores the OS (operating system), control programs, application programs, and the like. The I/F 75 is a device for connecting the bus 76, the LCD 77, the console unit 78, and the transmission apparatus 11. The LCD 77 is a visual user interface for transmitting information to a user. The console unit 78 is a user interface for a user to input information to the external terminal 12, and it is for example a keyboard, a mouse, or a touch panel.

The external terminal 12 reproduces content such as moving images or sounds in accordance with a user's operation and outputs media signals including image data, sound signals, and the like. The external terminal 12 is connected to the transmission apparatus 11 so as to output media signals to the transmission apparatus 11.

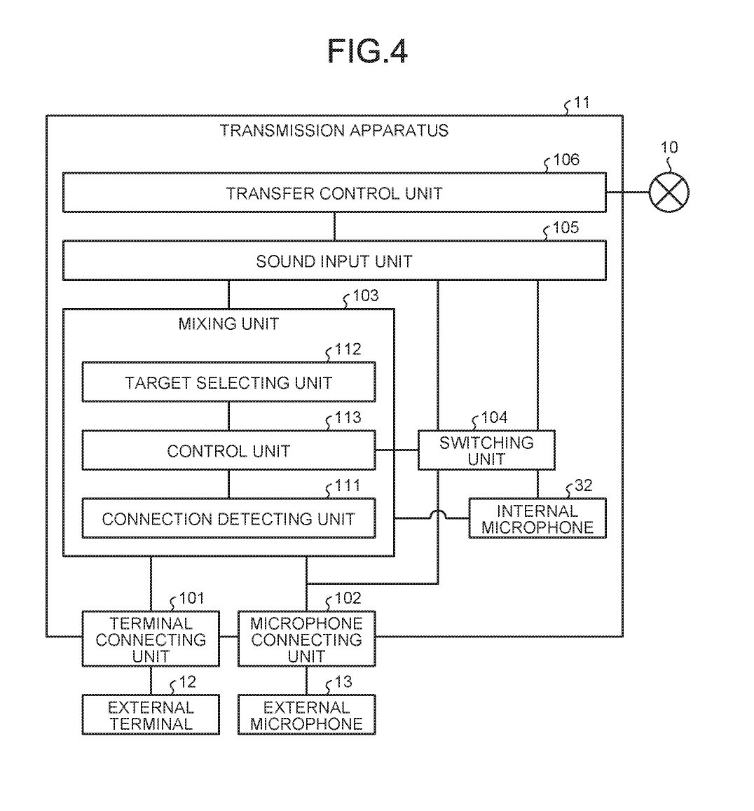

FIG. 4 is a diagram that illustrates an example of the functional configuration of the transmission apparatus 11 according to the embodiment. The transmission apparatus 11 includes a terminal connecting unit 101 (the first connector), a microphone connecting unit 102 (the second connector), a mixing unit 103 (the mixer), a switching unit 104 (a switch), a sound input unit 105, and a transfer control unit 106 (the transfer controller).

The terminal connecting unit 101 allows the external terminal 12 to connect to the transmission apparatus 11. The terminal connecting unit 101 conducts a recognition process to recognize the external terminal 12, a communication process to transmit and receive data to and from the external terminal 12, and the like. The communication process includes receiving media signals (sound signals, video signals, and/or the like) output from the external terminal 12. The terminal connecting unit 101 is configured by using the external-terminal connection I/F 35, the CPU 21, or the like.

The microphone connecting unit 102 allows the external microphone 13 to connect to the transmission apparatus 11. The microphone connecting unit 102 conducts a recognition process to recognize the external microphone 13, a communication process to transmit and receive data to and from the external microphone 13, and the like. The communication process includes receiving sound signals output from the external microphone 13. The microphone connecting unit 102 is configured by using the sound input/output I/F 33, the CPU 21, or the like.

The mixing unit 103 mixes a sound signal from the external terminal 12 and a sound signal from the external microphone 13 or and a sound signal from the internal microphone 32. The mixing unit 103 is configured by using the sound input/output I/F 33, the external-terminal connection I/F 35, the CPU 21, or the like.

The mixing unit 103 includes a connection detecting unit 111 (the detector), a target selecting unit 112 (the selector), and a control unit 113.

The connection detecting unit 111 detects the external terminal 12 connected to the terminal connecting unit 101 and detects the external microphone 13 connected to the microphone connecting unit 102. The method for detecting the external terminal 12 needs to be optionally selected in accordance with a usage condition, or the like. For example, a state where the external terminal 12 is physically connected to the terminal connecting unit 101 and is outputting a media signal may be recognized as that the external terminal 12 is “detected”. Alternatively, a state where the external terminal 12 is simply physically connected to the terminal connecting unit 101 may be recognized as that the external terminal 12 is “detected”.

The target selecting unit 112 selects a sound signal targeted for mixing depending on a detection result of the connection detecting unit 111. Details of the method for selecting a sound signal by the target selecting unit 112 are given later.

The control unit 113 controls mixing between a sound signal from the external terminal 12 and a sound signal from the external microphone 13, or and a sound signal from the internal microphone 32 depending on a detection result by the connection detecting unit 111 and a selection result by the target selecting unit 112. Depending on a detection result by the connection detecting unit 111 and a selection result by the target selecting unit 112, the control unit 113 performs a process for switching between a sound signal from the internal microphone 32 and a sound signal from the external microphone 13 as a sound signal to be transferred without mixing.

In accordance with a control signal from the control unit 113, the switching unit 104 switches between a sound signal from the internal microphone 32 and a sound signal from the external microphone 13 as a sound signal to be transferred to another transmission apparatus 11 (the one or more second transmission apparatuses) without mixing. The switching unit 104 according to the present embodiment functions to input, to the sound input unit 105, either the sound signal output from the internal microphone 32 or the sound signal output from the external microphone 13. The switching unit 104 is configured by using the sound input/output I/F 33, the CPU 21, or the like.

The sound input unit 105 takes in a sound mixed by the mixing unit 103 or a sound signal (a sound signal from the internal microphone 32 or a sound signal from the external microphone 13) input from the switching unit 104. The sound input unit 105 is configured by using the sound input/output I/F 33, the CPU 21, the flash memory 24, the SSD 25, the recording medium 26, the medium drive 27, or the like.

The transfer control unit 106 performs a process to transfer sound signals input to the sound input unit 105, that is, a mixed sound signal or a sound signal that has not been mixed, to another transmission apparatus 11 via the network 10. The transfer control unit 106 is configured by using the network I/F 30, the CPU 21, or the like. Note that, in the present embodiment, the term “transfer” is used as a synonym for “transmit”.

As described above, the target selecting unit 112 in the mixing unit 103 according to the present embodiment selects a sound signal targeted for mixing depending on a detection result by the connection detecting unit 111. The target selecting unit 112 selects a mixing target on the basis of, for example, the mixing-target selection table described below.

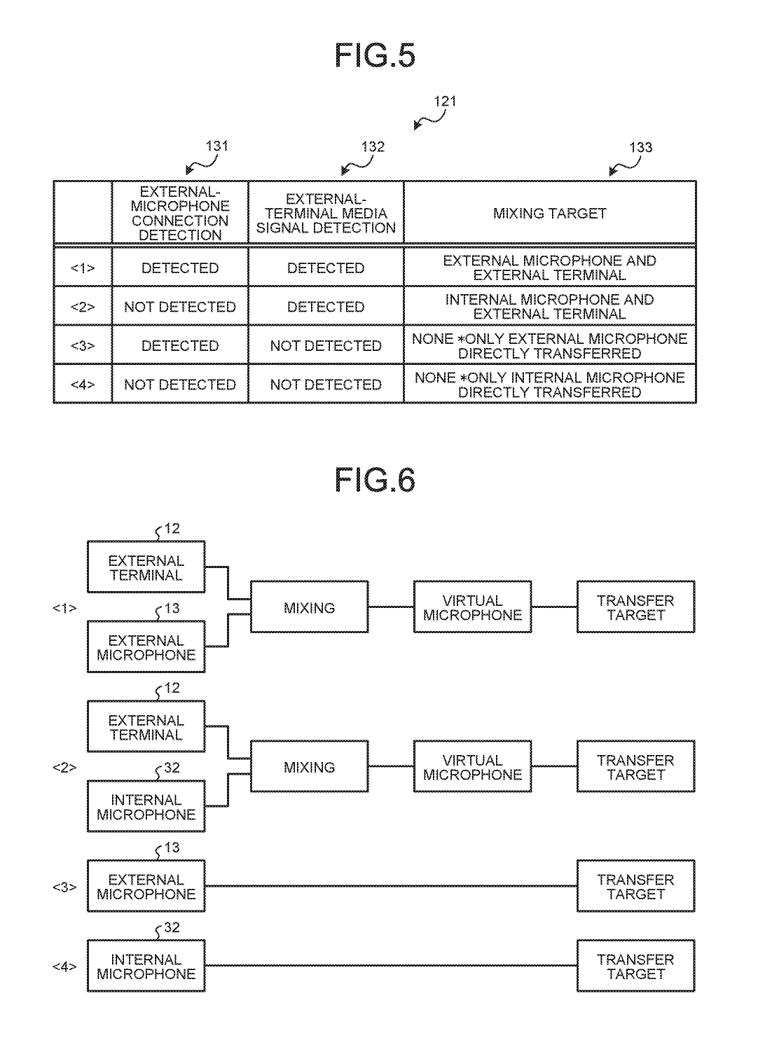

FIG. 5 is a diagram that illustrates an example of the data structure of a mixing-target selection table 121 according to the embodiment. The mixing-target selection table 121 according to the present embodiment includes columns 131, 132, and 133. The “external-microphone connection detection” column 131 indicates whether or not the external microphone 13 is connected. The “external- terminal media signal detection” column 132 indicates whether or not a media signal is being input from the external terminal 12. The “mixing target” column 133 indicates a mixing target. The mixing-target selection table 121 also includes four mixing patterns <1>to <4>associating a detection result of the external microphone 13, a detection result of the external terminal 12, and a mixing target.

The first mixing pattern <1>represents that, when it is detected that the external microphone 13 is connected to the microphone connecting unit 102 and the external terminal 12 is outputting a media signal (the external terminal 12 is connected to the terminal connecting unit 101 and is outputting a media signal), a sound signal from the external microphone 13 and a sound signal from the external terminal 12 are handled as mixing targets.

The second mixing pattern <2>represents that, when it is detected that the external microphone 13 is not connected to the microphone connecting unit 102 and the external terminal 12 is outputting a media signal, a sound signal from the internal microphone 32 and a sound signal from the external terminal 12 are handled as mixing targets.

The third mixing pattern <3>represents that, when it is detected that the external microphone 13 is connected to the microphone connecting unit 102 and the external terminal 12 is outputting no media signal (the external terminal 12 is not connected to the terminal connecting unit 101, or the external terminal 12 is outputting no media signal although it is connected to the terminal connecting unit 101), mixing is not conducted and only a sound signal from the external microphone 13 is directly transferred.

The fourth mixing pattern <4>indicates that, when the external microphone 13 is not connected to the microphone connecting unit 102 and the external terminal 12 is outputting no media signal, mixing is not conducted and only a sound signal from the internal microphone 32 is directly transferred.

The above-described mixing-target selection table 121 is stored in an appropriate storage medium (for example, the ROM 22, the flash memory 24, the recording medium 26, or the like) and the target selecting unit 112 refers to the mixing-target selection table 121 as needed, whereby it is possible to perform a process to automatically select a mixing target depending on the connection states of the external terminal 12 and the external microphone 13.

FIG. 6 is a diagram that conceptually illustrates the transfer targets in the mixing patterns <1>to <4>according to the embodiment. In the first mixing pattern <1>, a sound signal from the external terminal 12 and a sound signal from the external microphone 13 are mixed, a result of the mixing is set as an output of a virtual microphone, and an output from the virtual microphone is set as a transfer target. In the second mixing pattern <2>, a sound signal from the external terminal 12 and a sound signal from the internal microphone 32 are mixed, a result of the mixing is set as an output of the virtual microphone, and an output from the virtual microphone is set as a transfer target. In the third mixing pattern <3>, mixing is not conducted, and only a sound signal from the external microphone 13 is set as a transfer target. In the fourth mixing pattern <4>, mixing is not conducted, and only a sound signal from the internal microphone 32 is set as a transfer target.

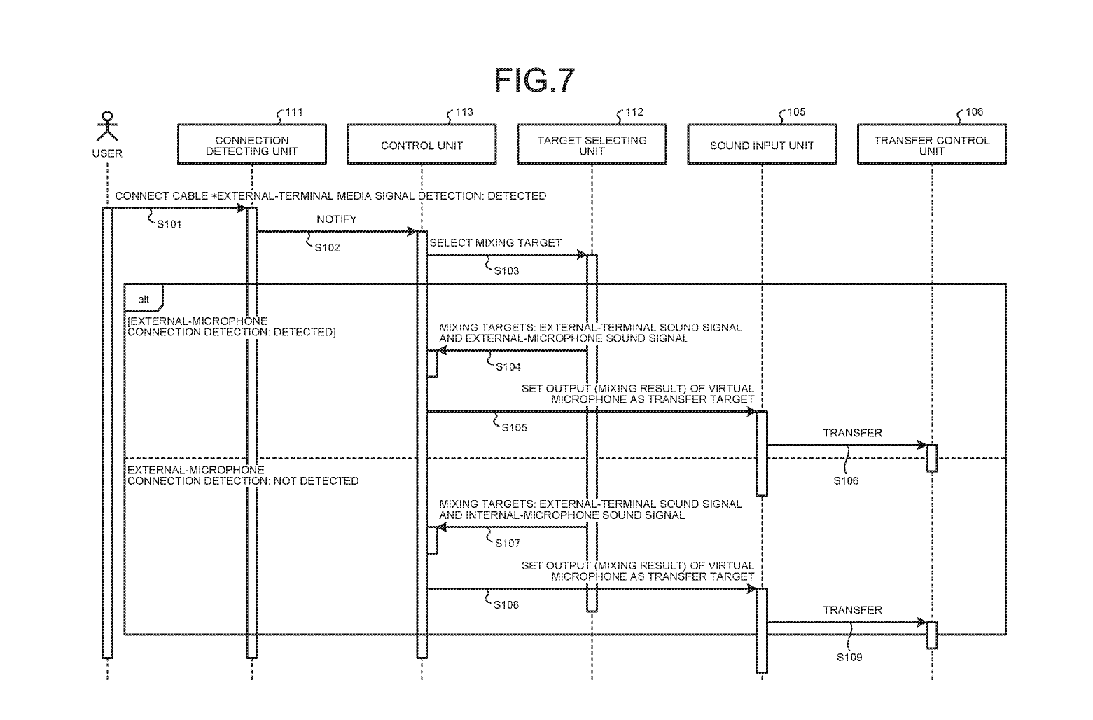

FIG. 7 is a flowchart that illustrates an example of the process when the transmission apparatus 11 conducts mixing according to the embodiment. After the external terminal 12 is connected to the transmission apparatus 11 via the cable by the user and the connection detecting unit 111 detects a media signal from the external terminal 12 (S101), the connection detecting unit 111 transmits, to the control unit 113, a notification indicating that a media signal is detected (S102). Upon receiving the notification, the control unit 113 causes the target selecting unit 112 to perform a process to select a mixing target (S103).

When a command to select a mixing target in a case where the external terminal 12 is detected is given by the control unit 113, the target selecting unit 112 acquires a detection result regarding the connection of the external microphone 13 from the connection detecting unit 111. When the external microphone 13 is detected (connected), the target selecting unit 112 determines, based on the mixing- target selection table 121, that a sound signal from the external terminal 12 and a sound signal from the external microphone 13 are the mixing targets and transmits a corresponding selection result to the control unit 113 (S104). Upon receiving the selection result from the target selecting unit 112, the control unit 113 sets an output (mixing result) of the virtual microphone as a transfer target and transmits a corresponding setting result to the sound input unit 105 (S105). After that, the transfer control unit 106 acquires, from the sound input unit 105, a mixing result, that is, a sound signal resulting from mixing a sound signal from the external terminal 12 and a sound signal from the external microphone 13, and transfers the sound signal as the mixing result to the transmission apparatus 11 at a communicating party (S106).

Conversely, when the external microphone 13 is not detected, the target selecting unit 112 selects a sound signal from the external terminal 12 and a sound signal from the internal microphone 32 as the mixing targets on the basis of the mixing-target selection table 121 and transmits a corresponding selection result to the control unit 113 (S107). Upon receiving the selection result from the target selecting unit 112, the control unit 113 sets an output (mixing result) of the virtual microphone as a transfer target and transmits a corresponding setting result to the sound input unit 105 (S108). After that, the transfer control unit 106 acquires, from the sound input unit 105, a mixing result, that is, a sound signal resulting from mixing a sound signal from the external terminal 12 and a sound signal from the internal microphone 32, and transfers the sound signal as the mixing result to the transmission apparatus 11 at the communicating party (S109).

The above-described process is capable of performing proper and automatic selection and switching of a mixing target when the external terminal 12 is outputting a media signal and mixing is conducted. In the example of the above-described process, detection of the external terminal 12 is executed based on the presence or absence of a media signal. Therefore, mixing is not executed when the external terminal 12 is outputting no media signal even when the external terminal 12 is physically connected to the transmission apparatus 11. This may prevent execution of unnecessary mixing and may prevent the occurrence of problems such as a decrease in the sound quality due to mixing.

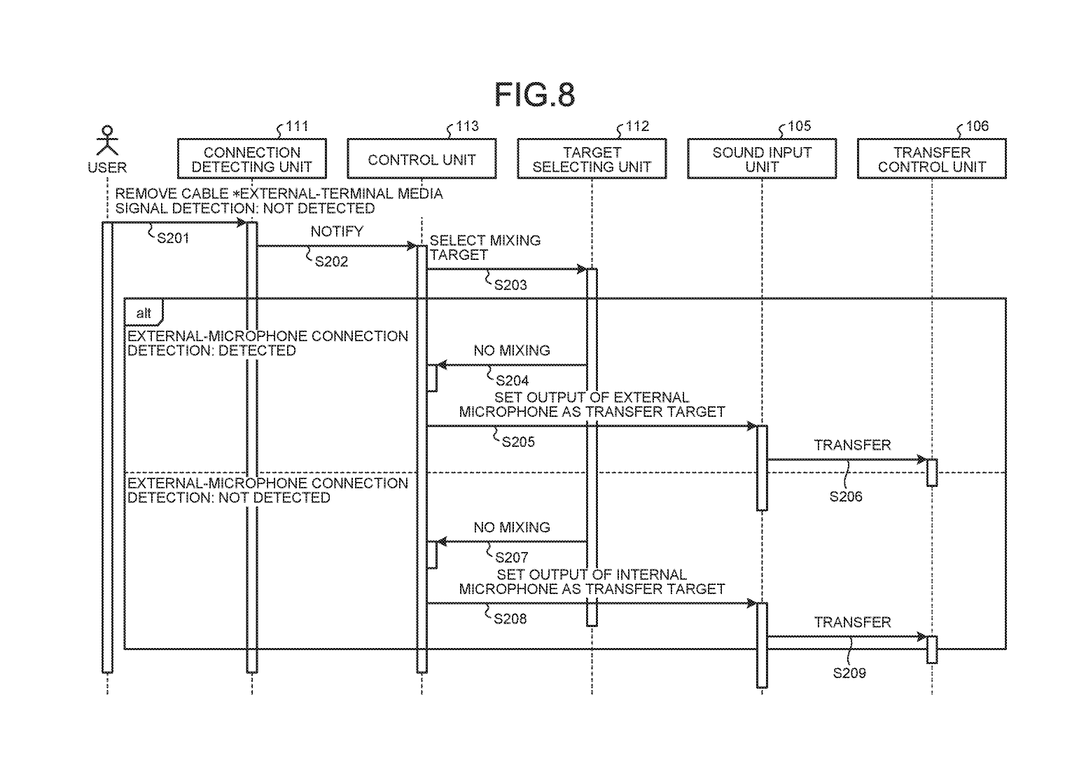

FIG. 8 is a flowchart that illustrates an example of the process when mixing is not conducted in the transmission apparatus 11 according to the embodiment. After the user removes the cable connected to the external terminal 12 from the transmission apparatus 11 so that a state is obtained such that the connection detecting unit 111 detects no media signal from the external terminal 12 (S201), the connection detecting unit 111 transmits a notification indicating that no media signal is detected to the control unit 113 (S202). Upon receiving the notification, the control unit 113 causes the target selecting unit 112 to perform a process to select a mixing target (S203).

When a command to select a mixing target in a case where the external terminal 12 is not detected is given by the control unit 113, the target selecting unit 112 acquires a detection result regarding the connection of the external microphone 13 from the connection detecting unit 111. When the external microphone 13 is detected, the target selecting unit 112 determines, based on the mixing- target selection table 121, that there is “no” mixing target and the transfer target is a sound signal from the external microphone 13 and transmits a corresponding selection result to the control unit 113 (S204). Upon receiving the selection result from the target selecting unit 112, the control unit 113 sets an output of the external microphone 13 as a transfer target and transmits a corresponding setting result to the sound input unit 105 (S205). After that, the transfer control unit 106 acquires a sound signal of the external microphone 13 from the sound input unit 105 and transfers the acquired sound signal to the transmission apparatus 11 at the communicating party (S206).

Conversely, when the external microphone 13 is not detected, the target selecting unit 112 determines, based on the mixing-target selection table 121, that there is “no” mixing target and the transfer target is a sound signal from the internal microphone 32 and transmits a corresponding selection result to the control unit 113 (S207). Upon receiving the selection result from the target selecting unit 112, the control unit 113 sets an output of the internal microphone 32 as the transfer target and transmits a corresponding setting result to the sound input unit 105 (S208). After that, the transfer control unit 106 acquires a sound signal of the internal microphone 32 from the sound input unit 105 and transfers the acquired sound signal to the transmission apparatus 11 at the communicating party (S209).

The above-described process is capable of performing proper and automatic selection and switching of the target sound signal to be transferred when the external terminal 12 is outputting no media signal and mixing is not conducted.

Although the method for detecting the external terminal 12 based on the presence or absence of a media signal is illustrated by an example in the above embodiment, this is not a limitation. For example, the external terminal 12 may be detected based on only the presence or absence of physical connection of the external terminal 12.

Although the external terminal 12 is a PC in the case illustrated by an example in the above embodiment, this is not a limitation. The external terminal 12 may be any device that outputs sound signals, and it may be, for example, a smartphone, a tablet terminal, a voice recorder, a digital camera, a digital video camera, a television, or a music player.

Although the external terminal 12 is connected to the transmission apparatus 11 via the cable in the configuration illustrated by an example in the above embodiment, this is not a limitation. For example, the connection between the external terminal 12 and the transmission apparatus 11 may be established by using a near field communication such as Bluetooth. The same holds for the connection between the external microphone 13 and the transmission apparatus 11.

Although communications are performed among the transmission apparatuses 11 connected to the network 10 in the configuration illustrated by an example in the above embodiment, this is not a limitation. For example, communications may be performed between the transmission apparatus 11 and a general-purpose PC (information processing apparatus) that has a teleconference application enabling communications with the transmission apparatus 11 installed therein and is connected to the network 10.

As described above, according to the present embodiment, a sound signal targeted for mixing and a sound signal transferred without mixing are selected and switched based on detection results on the external terminal 12 and the external microphone 13. Thus, it is possible to properly and automatically switch a mixing target in the transmission apparatus 11 (11A) on the transmitting side depending on the connection state of a peripheral device.

According to the present invention, it is possible to properly and automatically switch a mixing target in a transmission apparatus on the transmitting side depending on the connection state of a peripheral device.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus as a special-purpose circuit or device, or as a hardware/software combination, such as a processor executing a software program.

Further, as described above, any one of the above- described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A transmission apparatus comprising:
a first connector configured to allow an external terminal to connect to the transmission apparatus;
a second connector configured to allow an external microphone to connect to the transmission apparatus;
a detector configured to detect the external terminal connected to the first connector and detect the external microphone connected to the second connector;
a mixer configured to mix a sound signal output from the external terminal and a sound signal output from the external microphone or and a sound signal output from an internal microphone provided in the transmission apparatus;
a selector configured to select a sound signal, which is targeted for mixing, based on a detection result of the detector; and
a transfer controller configured to transfer, to one or more second transmission apparatuses, a sound signal resulting from the mixing by the mixer.

2. The transmission apparatus according to claim 1, wherein the selector
determines, as targets for mixing, a sound signal from the external terminal and a sound signal from the external microphone when the external terminal is detected and the external microphone is detected, and
determines, as targets for mixing, a sound signal from the external terminal and a sound signal from the internal microphone when the external terminal is detected and the external microphone is not detected.

3. The transmission apparatus according to claim 1, wherein, when the detection result of the detector indicates that the external terminal is not detected,
the selector determines that a sound signal to be transferred is either a sound signal from the external microphone or a sound signal from the internal microphone, and
the transfer controller transfers the sound signal determined by the selector to the one or more second transmission apparatuses.

4. The transmission apparatus according to claim 3, further comprising a switch configured to forward, toward the transfer controller based on the determination of the selector, either a sound signal from the external microphone or a sound signal from the internal microphone,
wherein the selector determines that
the signal to be transferred is a sound signal from the external microphone when the external terminal is not detected and the external microphone is detected, and
the signal to be transferred is a sound signal from the internal microphone when neither the external terminal nor the external microphone is detected.

5. The transmission apparatus according to claim 1, wherein, when no media signal is output from the external terminal while the external terminal is physically connected to the first connector, the detector outputs a detection result indicating that the external terminal is not detected.

6. The transmission apparatus according to claim 1, wherein, when the external terminal is physically connected to the first connector, the detector outputs a detection result indicating that the external terminal is detected.

7. A teleconference system comprising:
a transmission apparatus; and
one or more information processing apparatuses connected to the transmission apparatus via a network, wherein the transmission apparatus includes:
a first connector configured to allow an external terminal to connect to the transmission apparatus;
a second connector configured to allow an external microphone to connect to the transmission apparatus;
a detector configured to detect the external terminal connected to the first connector and detect the external microphone connected to the second connector;
a mixer configured to mix a sound signal output from the external terminal and a sound signal output from the external microphone or and a sound signal output from an internal microphone provided in the transmission apparatus;
a selector configured to select a sound signal, which is targeted for mixing, based on a detection result of the detector; and
a transfer controller configured to transfer, to the one or more information processing apparatuses, a sound signal resulting from the mixing by the mixer.

8. An information processing method for a system including a transmission apparatus and one or more information processing apparatuses connected to the transmission apparatus via a network, the information processing method comprising:
detecting an external terminal connected to the transmission apparatus and detecting an external microphone connected to the transmission apparatus;
mixing a sound signal output from the external terminal and a sound signal output from the external microphone or and a sound signal output from an internal microphone provided in the transmission apparatus;
selecting a sound signal, which is targeted for mixing, based on a detection result of the detecting; and
transferring, to the information processing apparatus, a sound signal resulting from the mixing.

9. A non-transitory computer readable recording medium on which an executable program is recorded, the program instructing a computer to execute:
detecting an external terminal connected to the computer and detecting an external microphone connected to the computer;
mixing a sound signal output from the external terminal and a sound signal output from the external microphone or and a sound signal output from an internal microphone provided in the computer;
selecting a sound signal, which is targeted for mixing, based on a detection result of the detecting; and
transferring, to an information processing apparatus, a sound signal resulting from the mixing.
